(19) United States
(12) Patent Application Publication
(10) Pub. No.: US 2020/0356774 A1
(43) Pub. Date: Nov. 12, 2020

(54) SYSTEMS AND METHODS FOR AEROSTAT MANAGEMENT INCLUDING IDENTIFYING, CLASSIFYING AND DETERMINING PREDICTIVE TRENDS OF AN ENTITY OF INTEREST

(71) Applicant: SAP NATIONAL SECURITY SERVICES, INC., Newtown Square, PA (US)

(72) Inventors: David KORN, Abington, PA (US); Donald HOWE, Edgewater, MD (US); Michelle ESLER, Bethesda, MD (US)

(21) Appl. No.: 16/867,207

(22) Filed: May 5, 2020

Related U.S. Application Data
(60) Provisional application No. 62/843,834, filed on May 6, 2019.

(51) Int. Cl. G06K 9/00; G06K 9/62

(52) U.S. Cl. CPC G06K 9/00651; G06K 9/6253; G06K 9/00711; G06K 9/6256

(57) ABSTRACT

A system for identifying and determining predictions of an entity of interest (EOT) includes a processor configured to receive real-time FMV data of an area of interest (AOI); a memory operatively coupled to the processor and storing a machine learning algorithm for identifying the EOT in the AOI; a database for use in classifying the EOT and determining predictions associated with the EOT; and a translator operatively coupled to the processor and configured to cause the processor to operationally communicate with the machine learning algorithm. The processor may be further configured to correlate a stored video data with the current video data and cause the database to store the correlated video data with its associated EOT. The processor may be configured to determine predictions associated with the EOT by identifying trends in the correlated video data.

### CROSS-REFERENCE TO RELATED APPLICATIONS

This application claims priority to the U.S. provisional patent application Ser. No. 62/843,834, filed May 6, 2019. Priority to the provisional patent application is expressly claimed, and the disclosure of the provisional application is hereby incorporated herein by reference in its entirety and for all purposes.

### FIELD OF THE PRESENT INVENTION

The present invention relates to systems and methods the for tagging, tracking and locating (TTL) of unknown entities of interest (EOT), more particularly, to using a machine learning algorithm to identify an EOT from video data and correlating stored video data and current video data obtained from video signals transmitted by an aerostat to determine predictions and trends associated with the EOT.

### BACKGROUND OF THE PRESENT INVENTION

Within the Intelligence and Department of Defense (DoD) Intelligence, Surveillance, and Reconnaissance (ISR) communities and their counterparts in the industrial and commercial sectors are experts who know how to identify, and track targets via coordinated data sources. These organizations understand how to task and deploy assets to collect imagery, full motion video, and sensor data when “we know what to look for” and “where to look” to find potential adversarial targets and activities. The problem relates to how to identify an adversarial target, event or activity when one is not actively looking, but at the same time is being inundated with data from multiple sources. A subset of this larger problem is determining how to find something and gain relevant alerts from these multiple data sources when they are deployed for a mission requiring continuous persistent surveillance over a selected area of interest (AOI).

Unfortunately, the interaction among the multiple sources of data collection and processing is not seamless and is dependent on human interaction to provide feedback, re-planning and tasking to perform additional collections to acquire the data necessary to support mission needs. The problem is not with the sources of data, it's the lack of contextual sense making from the collected data to generate courses of action for operators to review. With the proper contextual sense making, an operator could take a course of action such as re-tasking assets to collect additional data, detect, and classify unexpected targets with minimal human intervention.

While there have been advances in providing “tipping and cueing” interaction between sensor systems (image, full motion video (FMV), social media, communication signals, etc.) to acquire additional sensor information, it is not usually accomplished in the context of direct support to the mission being executed.

What is needed is a field deployable platform with hardened security and the ability to perform real-time target/entity detection, classification and geo-temporal correlation of known, as well as unanticipated targets from full motion video within a given area of interest under persistent surveillance. The field deployable platform must also “fuse” the exploited video/image data with other exploited data such as RF signals, message traffic and social media to provide a comprehensive common operating picture and situational awareness within the area of interest under surveillance. In order to accomplish this, a solution will require more than just “intelligent” software.

While there have been improvements in field deployable platforms, there remains a need for further improvements. For example, there remains a need for providing a field deployable platform with the following:
1. Hardware based hardened security capability from the processor BIOS up through the hypervisor and application containers to protect mission critical applications from infiltration of malware to unauthorized exfiltration of exploited content;
2. Hardware acceleration that implements machine learning algorithms for target/entity detection and classification, video/image processing, and predictive analysis;
3. Hardware acceleration for real time video moving target indication (VMTI), cursor on target (COT), and video compression to provide an “as-it-happens” view of the area of interest;
4. Edge Processing analysis application that integrates easy to use analytics functions with machine learning, video and image accelerators to “fuse” information from multiple sources and provide an interactive user interface; and
5. Small, ruggedized, portable computer platform (1U, 44 cores, 1 TB memory, 30 TB SSD) with a SWAP (size, weight and power) that allows for rapid deployment in any tactical situation (land, sea, air, space).

Accordingly, the present invention addresses these and other disadvantages of conventional field deployable platforms.

### SUMMARY OF THE PRESENT INVENTION

The present invention relates to a system for identifying and determining predictions regarding an entity of interest (EOT), wherein the system comprises a processor configured to receive a video signal of an area of interest (AOI), and a memory storing a machine learning algorithm for use in identifying the EOT in the AOI and storing a database for use in classifying the EOT and determining predictions associated with the EOT. The memory is operatively coupled to the processor. The system further comprises a display operatively coupled to the processor, a user interface operatively coupled to the processor and configured to receive a user input and a translator operatively coupled to the processor and configured to cause the processor to operationally communicate with the machine learning algorithm. The processor is configured to identify video data from each video frame associated with the video signal and store the video data in the database as stored video data. Further, the processor is configured to receive a current video signal of the AOI and identify current video data from each video frame associated with the current video signal. The processor may be configured to identify the EOT from the stored video data and the current video data using the machine learning algorithm, and store the EOT in the database. The processor may also be configured to correlate the stored video data with the current video data to update the stored video data and generate correlated video data, and cause the database to store the correlated video data with its associated EOT. To determine predictions associated with the EOT, the processor is configured to identify trends in the correlated video data. The display is configured to display at least a portion of the database.

In another embodiment, a system is provided for determining roads traversable during a predetermined travel time in a geographic sector. The system comprises a memory including computer instructions; and a processor coupled to the memory and, in response to executing the computer instructions, is configured to: receive data including all the roads in the geographic sector starting from a starting point; divide the geographic sector into slices in response to a value of a density parameter; cause display on a monitor a longest road in each slice of the slices; determine a road intersection point of a first road starting from the starting point with a nearest road; and use the road intersection point as a starting point for determining all possible roads for traversals from the road intersection point based the predetermined travel time and speed of travel over the roads in the each slice. The data may be obtained from a map stored in a database, and/or may be from image analysis of an image of the geographic sector.

The present system provides many advantages including aggregating data to provide auto detection/identification, classification and correlation of entities of interest (e.g., people, vehicles, bicycles) in real-time FMV and fusing with telematics data captured by a transceiver(s) (e.g., video camera) mounted on an aerostat to provide situational awareness (SA) and/or a common operating picture (COP) over multiple area of responsibilities (AORs).

### BRIEF DESCRIPTION OF THE DRAWINGS

The present invention is explained in further detail in the following exemplary embodiments and with reference to the figures, where the features of various exemplary embodiments being combinable. In the drawings:

FIG. 1 is a block diagram of a system for identifying and determining predictions of an entity of interest, in accordance with the invention;

FIG. 2 is a flow chart showing an exemplary context driven asset tasking and re-tasking, in accordance with the invention;

FIG. 3 is a flow chart showing an exemplary elements for use in an automated asset re-tasking, in accordance with the invention;

FIG. 4 is a block diagram showing difference between a hardened capability vs. “standard hypervisor configuration, in accordance with the invention;

FIG. 5 is a block diagram showing an exemplary system architecture for creating a distributed tactical edge-to-cloud analytics solution, in accordance with the invention;

FIG. 6 is a flow chart showing an overview of the present system using exemplary computer programs or software, in accordance with the invention;

FIG. 7 is a flow diagram showing an exemplary tagging, tracking and locating (TTL) processing flow, in accordance with the invention;

FIG. 8 provides an example of a FMV video signal which may be received by a processor of the present system, in accordance with the invention; and

FIGS. 9-11 provide an example of determining possible roads in an area of interest.

### DETAILED DESCRIPTION OF THE PRESENT INVENTION

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments departing from these details would still be understood to be within the scope of the appended claims. Moreover, for the purpose of clarity, detailed descriptions of well-known devices, circuits, tools, techniques, and methods are omitted so as not to obscure the description of the invention. It should be expressly understood that the drawings are included for illustrative purposes and do not represent the entire scope of the invention. In the accompanying drawings, like reference numbers in different drawings may designate similar elements. The term and/or and formatives thereof should be understood to mean that only one or more of the recited elements may need to be suitably present (e.g., only one recited element is present, two of the recited elements may be present, etc., up to all of the recited elements may be present) in a system in accordance with the claims recitation and in accordance with one or more embodiments of the invention.

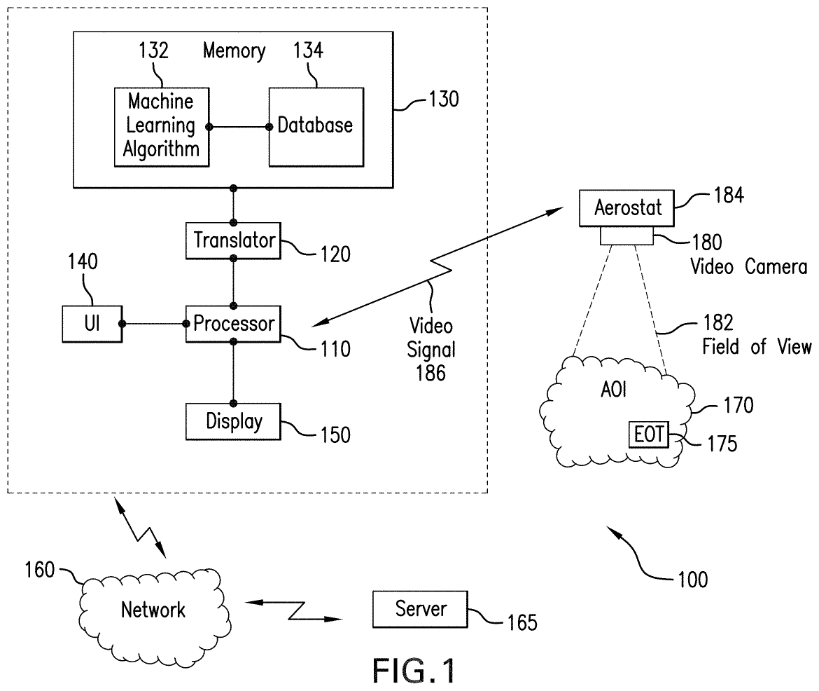

FIG. 1 shows a block diagram of a system 100 operating in accordance with one embodiment of the invention for identifying an EOT within a target region or AOI and determining predictions associated with the EOT. The system 100 may include various elements such as a processor 110 which may be operationally coupled to other elements of the system, such as a programming language processor or translator 120, a memory 130, a user interface 140, and a display 150 which may be stand-alone display or part of another device such as a computer system, laptop, mobile phone, heads-up display, etc.. Memory 130 may store a machine learning algorithm 132 and a database 134. Further, processor 110 may be a singular processor or a collection of distributed processors, such as having processors and/or controllers included with the various system elements. For example, the translator 120 and display 150 may have their own dedicated processors that collectively with other distributed processors of the system 100 are referred to as the processor 110 of the system 100. Similarly, memory 130 may be a singular memory or a collection of distributed memories such as having memories and/or modules included with the various system elements where, for example, the machine learning algorithm 132 and a database 134 may have their own dedicated memories that collectively with other distributed memories of the system 100 are referred to as the memory 130 of the system 100.

At least one of the elements of the system 100 may be operatively connected to a network 160, such as the Internet or local area networks, for communicating with a remote server 165, a remote memory, a remote display, and/or a remote UI through the network 160. Server 165 may have its own processor, memory, display and UI as is well-known. All or some parts or elements of the system 100 may be connected to the network 160 and server 165, directly or indirectly, through well-known connections, which may be wired and/or wireless, such as via wire cables, fiber optics, satellite or other RF links, Bluetooth™, e.g.. Similarly, the various elements of the system 100 may be interconnected, directly or indirectly via well-known wired and/or wireless connections such as wire cables, fiber optics, Bluetooth™, as well as long range links such as satellite or other RF links.

As shown in FIG. 1, the processor 110 is operationally coupled to the memory 130 which may be any tangible non-transitory computer-readable memory medium. Memory 130 may also include a computer program including instructions when executed by the processor 110 that causes processor 110 to perform various functions, step and/or acts. For example, a computer program in memory 130 may cause processor 110 to identify, within an AOI 170, an EOT 175, determine predictions associated with the EOT 175 and/or provide designated or selected recipients, indications, alerts or warnings about the EOT 175. The processor 110, the memory 130, as well as other elements shown in FIG. 1 may be co-located near each other, and/or may be remote from each other and operationally coupled or connected through a local area network and/or the network 160 shown in FIG. 1 such as the Internet, through secure connections where communications therebetween may be encrypted, for example.

Memory 130 stores the machine learning algorithm 132 which may be used in system 100 for identifying the EOT 175 in the AOI 170. Database 134, stored in memory 130, may be used for classifying or categorizing EOT 175 and for determining predictions or trends associated with EOT 175.

Translator 120 operatively coupled to processor 110 may be configured to cause processor 110 to operationally communicate with machine learning algorithm 132.

AOI 170 may be any geographic space having a predetermined size and/or coordinates. AOI 170 may be selected or inputted by a user at UI 140 or may be automatically selected by processor 110 based on, for example, predictions or trends identified and associated with EOT 175. Similarly, EOT 175 may be any tangible item, such as for example, person, animal, bicycle, vehicle and the like. EOT 175 may be a moving target.

Processor 110 may be operationally coupled or connected to a video camera 180 which may be coupled to aerostat 184, such as a flyable drone which may be remotely controlled by an operator and/or autonomously controlled by a preprogrammed processor including machine learning capabilities to fly over an EOT as directed by the operator and/or by based on instructions from the machine learning program that determines the EOT and controls the drone to fly over the determined EOT. The video camera 180 may communicate (receive and/or transmit 182, 186) video signals through wireless and/or wired connections which may be via known communication protocols that may include encryption to enhance security. To further increase security, video communication (full motion and/or still images) may be through a proprietary video telemetry bus within the software solution of the present system 100. Video camera 180 may be in a visual field of view 182 of AOI 170 and/or EOT 175, and configured to take real-time full motion video (FMV) of the AOI 170 and/or the EOT 175. Video camera 180 for use in system 100 may be any FMV camera as known by one skilled in the art, as the present system is envisioned to be camera agnostic. Video camera 180 may be attached to or integrated with a video data source, such as aerostat 184.

Video camera 180 receives a FMV signal of AOI 170 and transmits video signal 186 to processor 110 for converting video signal 186 into video data. Alternately or in addition, video camera 180 may have its own processor or controller configured to convert the video signal to video data and provide the video data to system processor 110.

Processor 110 is configured to receive video signal 186 of AOI 170 and to identify the video data from each video frame associated with video signal 186. The identified video data may include telemetry data, meta-data associated with each frame of the video (video frame) and image data associated with each video frame of the FMV captured of AOI 170. Processor 110 may be configured to receive video signal 186 through a wireless connection. Processor 110 may be configured to store the video data in database 134 as stored video data.

Processor 110 is configured to receive current or further video signals 186 of AOI 170 and identify current video data from each video frame associated with the current video signal. The AOI associated with the current video signal may be the same geographic space as the previously received video signals or may be adjusted or changed by processor 110, based on user input at UI 140 or automatically by processor 110 based on predicted and/or identified trends data stored in database 134. For example, the system receives information of a possible crowd gathering or riot, coupled with a detected disturbance or breaking news directly or indirectly detected by the system via the aerostat 184 or via information received from news or social media outlets, such as due to an incident reported in the news or on social media including an accident, a crime, and a popular or unpopular decision or speech by a figurehead or entity. Then, the system correlates people's movement with the breaking news, predicts and provides an alert(s) to responsible authorities, such as local law enforcement departments, about a possible riot and/or need for crowd control at a particular location. The system correlates and predicates based on the movement of people, such as walking, bicycling or driving in large numbers toward a particular direction predicted based on the direction of people's movement and a location associated with the event or disturbance, such as the location of the accident, the location of the figurehead giving a speech, or the location of the entity that issued the (popular or unpopular) ruling, for example. Processor 110 may be operationally coupled to aerostat 184 to provide it with instructions (directly or indirectly), such as change a location or change the size of the geographic area, thereby adjusting or changing AOI 170.

Processor 110 is configured to identify EOT 175 from the stored video data and the current video data using the machine learning algorithm 132, and store EOT 175 in database 134. Further, processor 110 is configured to correlate the stored video data with the current video data to update the stored video data and generate correlated video data. The correlated video data may be stored in the database 134 along with its associated EOT 175.

Processor 110 is configured to identify trends in the correlated video data stored in database 134, including based on correlating the various received inputs from various sources, such as events or news detected from social media or news outlet, thereby determining predictions associated with EOT 175. For example, predictions determined by processor 110 may include selected predictions associated with one or any combination of the following non-exhaustive list of predictions: a predictive path of the EOT; a predictive identity of the EOT; a predictive location of the EOT; a predictive action of the EOT; a predictive movement of the EOT; a predictive type of the EOT; a predictive classification of the EOT; and a predictive trend of the EOT. Processor 110 may be configured to display on the display 150 one or more of the trends identified and/or the predictions associated with EOT 175.

User interface 140 of system 100 may be configured to receive a user input to manipulate, change or adjust a source of the video data, such as aerostat 184, in response to predictions determined by processor 110 based on the correlated video data. For example, when comparison between stored and current video data reveals movement in a particular direction, then the aerostat 184 is moved in this particular direction to gather further video data and confirm that this predicted particular direction is the correct direction. Otherwise, the aerostat 184 collects further data with a larger field of view and reevaluates video data collected from the larger field of view, such as based on further comparison between stored and collected data as well as correlation with any additional relevant data from other sources, such as from other drones or aerostats near the current vicinity and/or information collected from social media, satellites, intercepted communication, etc. Alternatively or in addition, processor 110 may be configured to automatically manipulate, change or adjust the source of the video data, such as the aerostat 184, based on or in response to the predictions determined by processor 110. The manipulation of aerostat 184 may include providing instruction to change the location of aerostat 184 such that a different AOI (such as location or size) may be in the field of view 182. For example, processor 110 may manipulate aerostat 184 to move in order to track or monitor a moving EOT 175 and move aerostat 184 to the predicted or anticipated future location of EOT 175 based on the identified trends or predictions. Processor 110 may be configured to display the manipulation of aerostat 184 on display 150. UI 140 may be configured to receive a user input to change the manipulation displayed.

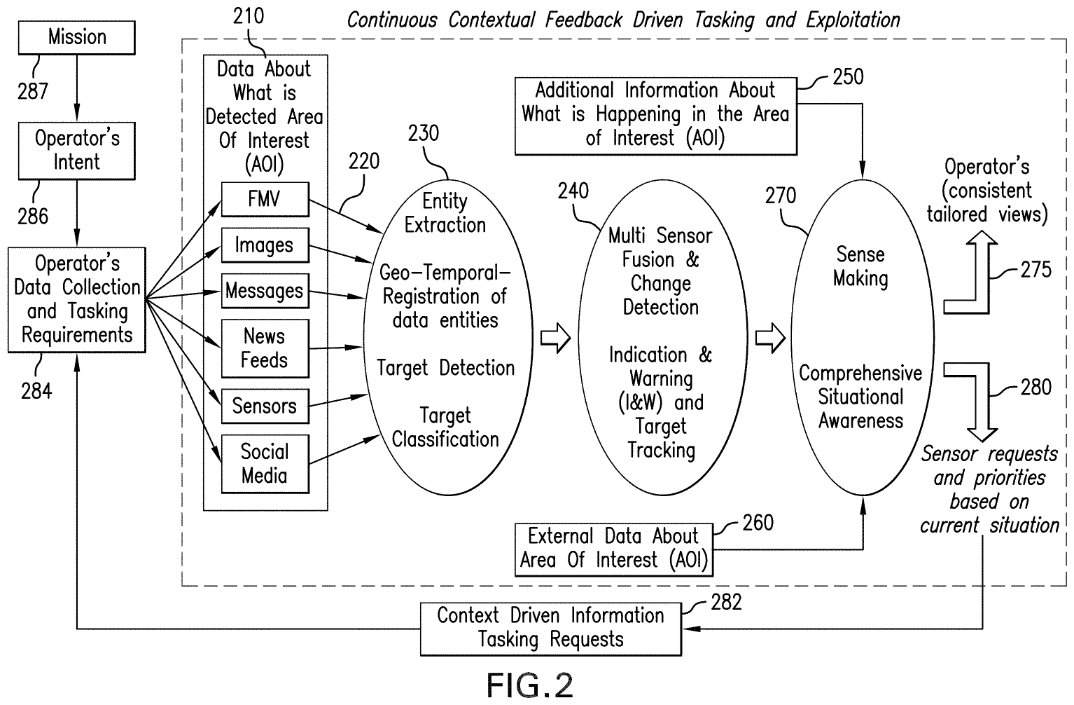

System 100 is radically innovative and modernizes the classical intelligence process with the capability to automate identification & warning mechanisms (I&W) when a “target of interest or entity” is detected that was not the focus of the collection based on correlation of data from multiple sources such as video and data information from multiple drones, multiple media and intelligence sources and/or multiple satellites and/or sensors, and may perform continuous machine learning based analytics to determine “where we should be looking next” based on existing target detection/classification information conflated with external information about the area of interest (AOI) where the target was detected. The goal is to migrate from a strategy of pre-placement of layered sensors that overlap and mapped to the AOI to a strategy where sensor coverage can be scaled up in near real time based on what is happening in the area of interest. FIG. 2 depicts this concept of context driven asset tasking and re-tasking, which includes upstream data fusion and sense making at the operational and tactical echelon.

As shown in FIG. 2, the processor 110 receives data 220 from multiple sources 210 that provide various data from various data entities and performs various operations. In particular, the processor 110 performs operation 230 that includes entity extraction, geo-temporal registration of the data entities, target detection and target classification. The data sources 210 provide data related to what is detected in the AOI and included in the FMV and images provided by the aerostat 184, as well as data related to messages from news feeds, social media and/or other sources, and other available sensors such as traffic cameras and/or other cameras or sensors located in the AOI. In addition, the processor 110, based on instructions stored in the memory 130 including the machine learning algorithm 132, performs operation 240 that includes multi-sensor fusion and change detection, as well as identification and warning (I&W) and target tracking. Next, in operation 270, based on results of operation 240, as well as additional information about what is happening in the AOI 250 and external data about the AOI 260, the processor 110 performs operation 270 of sense making and comprehensive situations awareness, to output correlated and fused data (including indications, predications or warnings based on the data analysis) to desired entities such as displaying 275 (on a display) results of predicted and/or consistent tailored views to the operator of the aerostat 184, as well as requesting 280 further information from the available sources. The requested further information 280 may be prioritized by the processor 110 and may include sensor requests and priorities based on the current situation. The request 280 may be provided as a context driven information tasking request 282 to an operator's data collection and tasking requirement system 284, which also receives operator's intent 286 based on the mission 287 for accessing the data sources 210 for needed information.

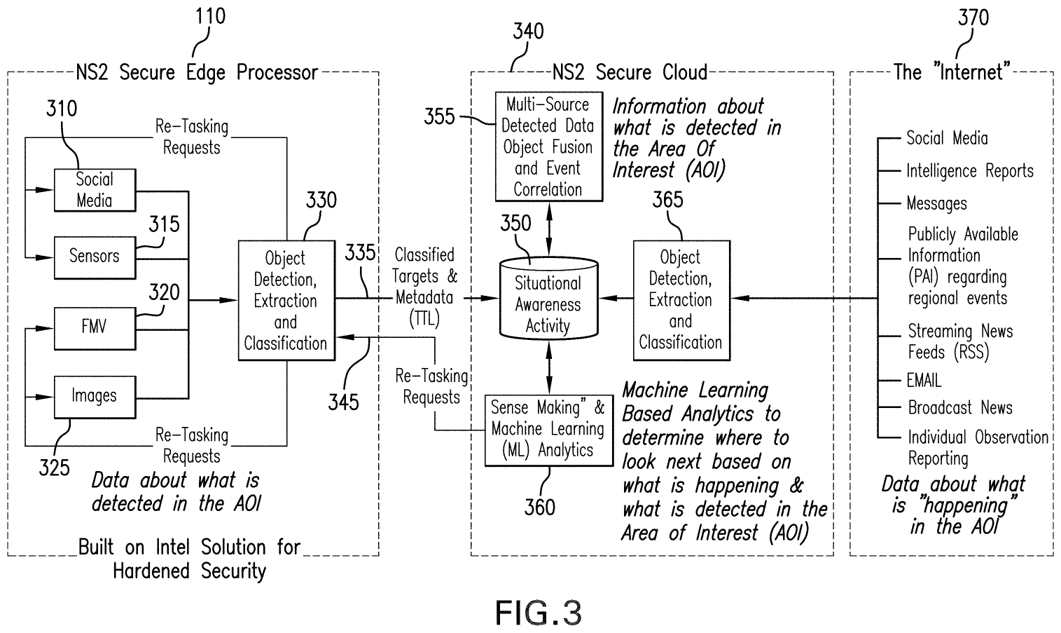

FIG. 3 shows exemplary elements that may be compiled, or “fused” to derive a complete operational picture of the area of interest under surveillance. First, is the ability of the processor 110 to acquire real time data of various types from multiple FMV sensors or cameras, on multiple platforms residing on disparate networks, such as from social media 310 and/or other sensors 315, as well as FMV 320 and images 325 provided by the aerostat 184 and/or available on social media 310 or obtained by the other sensors 315. The processor 110 has direct access to data sources 310, 315, 320, 325, where the data will be ingested into an Object Detection, Extraction and Classification (ODEC) application 330 stored in the memory 130 to determine the time and position of a detected target or entity based on the obtained data. This ODEC application 330 may be implemented, in part, by machine learning algorithm 132 in FIG. 1 and may re-task requests as needed to provide request additional or different information. The ODEC function is located at, for example, the Edge™ where operators are located. The ODEC functionality resides on, for example, a Dell XR2™, a ruggedized 1U computer (20″ deep) featuring Dual Intel Xeon™ processors (44 cores total), up to 1 TB memory and 30 TB of SSD storage. Alternatively or in addition to the processor 110 performing data analysis and fusion, a module (e.g., a SAP NS2's ODEC software module) inside the server 165 is configured to ingest full motion video and other camera/sensor data and to perform geo-temporal detection of targets/entities, classification and visualization of detected targets, inclusive of metadata associated with the FMV (KLV, MISB compliant). The detection and classification of targets may use, for example, Intel's Vision Processing Unit™ board family including, for example, Intel Movidius™ and Intel FPGA™ accelerators for AI inferencing installed in the Dell XR2™ server, for example. FMV is ingested by the ODEC application 330 and routed to the, for example, Intel™ VPU and processed in real-time by a machine learning algorithm (such as, for example Intel's™ machine learning algorithms) and associated models made available via, for example, OpenVINO™ (Open Visual Inference & Neural Network Optimization) toolkit for computer vision for Edge™ computing in EO/IR sensors, IoT devices RF signal sensors, images, documents, for example.

Second, is the ability to have an automated intelligent data fusion process that can be configured to handle different types of data (format, structure, unstructured, time series, event, e.g.) to perform analysis to establish the relationships among targets or entity objects. In particular, the processor 110 provides the detected/extracted and classified data output 335 (which includes classified targets and metadata) to a secure cloud 340 or server 165, which in turn performs further processing and also requests re-tasking 345 from the processor 110, as needed. The secure cloud 340 has a Situational Awareness Activity database 350 that receives and stores the detected/extracted and classified data output 335, as well as receives and stores further information from further sources. In particular, the situational awareness activity database 350 is operationally coupled to a multi-source detected data object fusion and event correlator 355 that processes, correlates and stores information about what is detected in the AOI. In addition, the situational awareness activity database 350 is operationally coupled to a sense making and machine learning analytics 360, which may be similar to the machine learning algorithm 132 stored in the memory 130 and includes enhanced capabilities. The machine learning analytics 360 is configured to determine where to look next based on what is happening and what is detected in the AOI. The situational awareness activity database 350 is further operationally coupled to an object detection, extraction and classification module 365 that received various inputs and data from the internet 370 and classifies such data based on current events, similar to the classifier 330 of the edge processor 110. The sources of data, such as obtained from the internet 370 include at least one of social media, intelligence reports, message, publicly available information (PAI) regarding regional events, streaming new feeds, emails, broadcast news and individual observation reporting from individuals located at or near the AOI providing observations, comments and/or reports, for example. Thus, the information from the internet 370 provides comprehensive data about what is happening in the AOI.

While the Edge™ Processing device or processor 110, for example, can perform the identification and classification of target entities, it does not have the ability to put them in context with other target data produced by other ground station Edge™ Processors, for example. As shown in FIG. 3, the situational awareness activity database 350 will encompass external data in addition to the processed FMV target/TTL information. External data, such as from the internet 370, will provide context to the AOI where targets, entities have been detected. For example, reports on violent events in a nearby area moving towards the AOI, and physical information regarding an identified entity coupled with social media data can influence the appropriate sensing phenomenology.

As shown in FIG. 3, this data fusion function is accomplished in, for example, the NS2 Secure Cloud™ 340 (or can be installed in any cloud environment, data center, field deployable processing at the operational level) using, for example, the HANA™ Intelligent Data Fusion Platform to establish the relationships among the targets and data processed at multiple Edge locations with other external data describing “what is happening” within the area of interest under surveillance using the enhanced ODEC application 365. This is accomplished using a similar ODEC application 330 of the edge processor 110 to identify, extract entities and facts and establishing their relationships. The Multi-Source Data Fusion application fuses the information processed at the Edge™ with information from external sources to provide a complete operating picture and situational awareness of the area of interest under surveillance. The Sense Making function is a machine learning based analytics application that uses the “fused” situational awareness information to determine where to look next based on what is happening and what is detected in the Area of Interest under surveillance. The results of this analysis will alert the analyst and the data collection sources with “tips and cues” to acquire additional data to extend the current analysis of the AOI under surveillance.

Secure processing of information is at the heart of the system. The aforementioned capability is a combination of computers at the Edge (in the field) and a centralized cloud based analytics application that can fuse data across multiple Edge locations with external data about each Edge location to provide an executive a complete picture of “what is happening, where/when it is happening, who is involved and where should I be looking next” to determine a set of course of action recommendations and their associated impacts.

There can be no leakage of information and infiltration of executable software of any kind to disrupt Edge and cloud processing operations. The Edge and cloud platforms offer protection mechanisms not offered by the traditional “secure product software vendors” and are able to respond to Systemic Threats in real time.

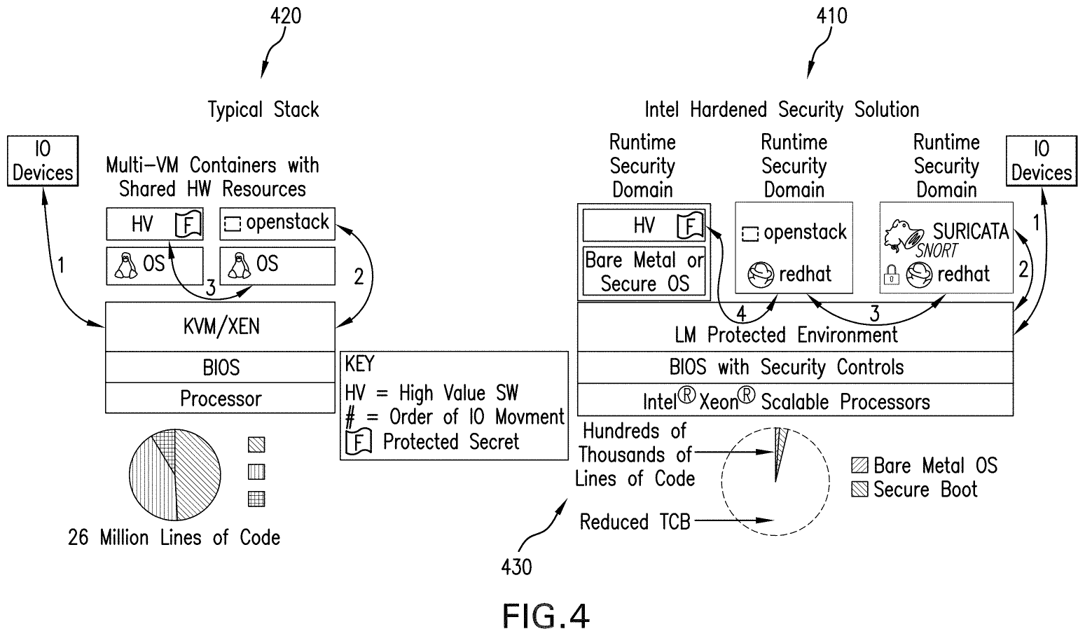

Protection measures against cyber threats commonly focus high in the enterprise stack at the virtual machine (VM), operating system (OS), and application levels. Conversely, threats are increasingly moving further down the stack, with advanced persistent threats using rootkits and other means to compromise low-level components such as hypervisors, boot drivers, BIOS, and firmware. The Intel Solution for Hardened Security™, for example, responds to that reality by extending protection all the way down the stack, reducing the attack surface and increasing workload isolation, as illustrated in FIG. 4.

FIG. 4 shows difference between a hardened capability 410 versus “standard hypervisor configuration” 420. The Intel Solution for Hardened Security™ 410 reduces the code size 430 of the trusted computer base for a smaller attack surface. The solution provides a hypervisor with approximately 60,000 lines of source code, or a fraction of the size of the open-source commercial XEN Project* hypervisor. Another thrust of the solution's design is to reduce vulnerabilities associated with sharing among multiple workloads of resources such as cores, memory, interrupts, and cache. The Intel Solution for Hardened Security™ 410 provides hardware firewalling that helps separate sensitive data from nontrusted workloads, providing cross-domain protection against leakage, modification, and privilege escalation. Isolation techniques create secured runtime domains within a protected operating environment.

Exemplary capabilities for runtime protection built into The Intel Solution for Hardened Security™ include the following:
1. Reduced threat surface of total code base compared to bloated, insecure open-source code;
2. Early cache partitioning and isolation of shared resources;
3. Cache and Core Isolation and Protected Memory;
4. Mandatory signed protected boot;
5. Elimination or isolation of Option ROM and foreign driver code;
6. Cryptographic signing of PCI Express* for white listing and black listing of devices;
7. Optional isolation and disablement of Intel® System Management Mode (SMM); and
8. Cryptographic ID support of attestation and encrypted communication.
   Other hardened security solutions may be envisioned for use in system 100 as is known by one skilled in the art.

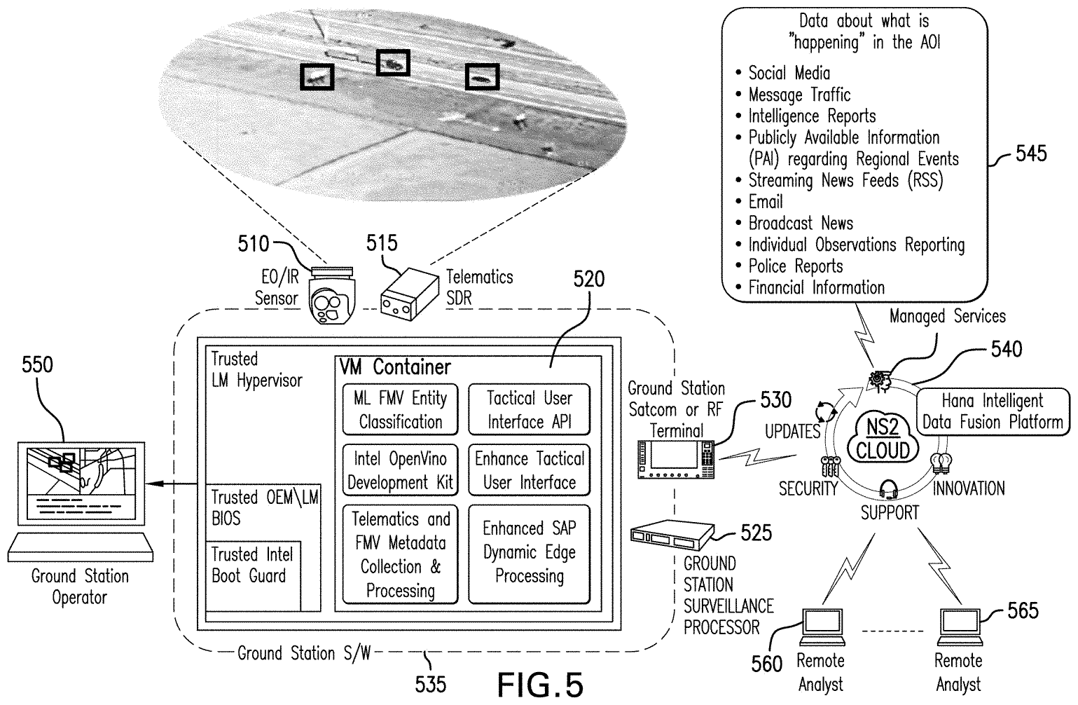

FIG. 5 illustrates an exemplary system architecture for use in the system. FIG. 5 shows how the components come together to create a distributed tactical edge-to-cloud analytics solution that provides for real time FMV geo-temporal detection and classification of targets under long dwell persistent surveillance. The machine learning aspects of this solution implemented on a secure platform allows operators to react to indications and warnings (I&W), or alerts to act instead of having to continuously watch video to detect potential targets and possibly miss them due to fatigue resulting in not acting when it was needed.

Exemplary elements shown in FIG. 5 include.
1. Real Time FMV and Image detection and classification using Intel Vision Processing Unit Cards™ supporting Intel Movidius™ and Intel FPGA™ accelerators with the OpenVINO™ machine learning inference optimization toolkit;
2. The Intel Solution for Hardened Security™ provides the secure platform; and
3. SAP Dynamic Edge™ Processing IoT Platform.
   These capabilities make it possible to provide capabilities at the edge where they are needed instead of having to send collected data to a remote data center to be processed reducing the value of the information.

As shown in FIG. 5, sensor 510 (the sensor can be an EO/IR Sensor) and sensor 515 collect data for storage in memory, such as a VM container 520 as used in a trusted LM hypervisor included in a processor, such as used in a ground station surveillance processor 525 of a ground station satcom or RF terminal 530 that form a ground station system 535. The data may also be collected by the secure cloud 540 for processing to secure, fuse, update and establish relationships among the data 545 about what is happening in the AOI from various sources, such as at least one of the social media, intelligent reports, message traffic, publicly available information regarding regional events, streaming new feeds, emails, broadcast news, individual observation reporting by individuals or organizations, police reports and financial information. The data 545 may also be collected by the secure cloud 540 and exchanged with the ground terminal 530. In turn, the data 545 is provided by the ground station 535, along with the data from sensors 510 and 515, to a ground station operator 550 for display on a monitor or display. Further, data is also exchanged between other remote ground terminals 560, 565 for display on monitors for review by further analysts. For example, specific or particular data may be selected and provided to the station operators or analysts in response from requests from the station operators or analysts.

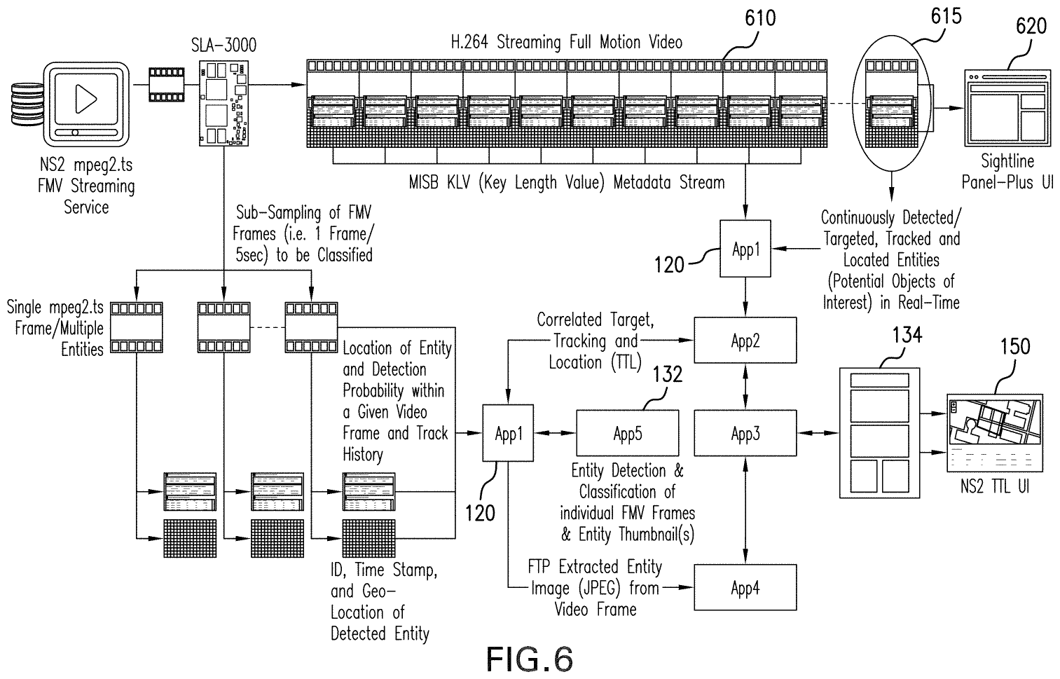

FIG. 6 shows a flow chart showing one embodiment of the system using exemplary computer programs or software executed by the processor 110 (FIG. 1) or another processor, such as a video processor 620. As is understood by a skilled person in the art other comparable computer programs, hardware and software may be used in the system. The processor 620 receives video frames 615 of a FMV stream 610 for display on a display of a user interface (UI) which may be part of the video processor 620, where the UI may be used by an operator to provide inputs or commands to the processor 110, 620. Processor 620 processes the video stream and outputs video frames 615 and metadata, including MISB KLV. Collectively, the video frames and metadata are video data. FIG. 6 depicts an exemplary video processor 620, Sightline™, for use with the system of this embodiment. As shown in FIG. 1 and in greater detail in FIG. 6, a translator 120, for example, python™, causes the Sightline™ video processor 620 to operationally communicate with a machine learning algorithm 132, for example, OpenVino™. Using the processed video stream and the machine learning algorithm, an EOT may be identified and stored in database 134. From the data stored in the database 134, trends may be identified by the processor 110, 620 from the data, thereby determining prediction associated with the EOT. All or portions of the database 134 may be displayed on the display 150 of a UI. The display or UI 150 may also display the trends and/or predictions associated with the EOT.

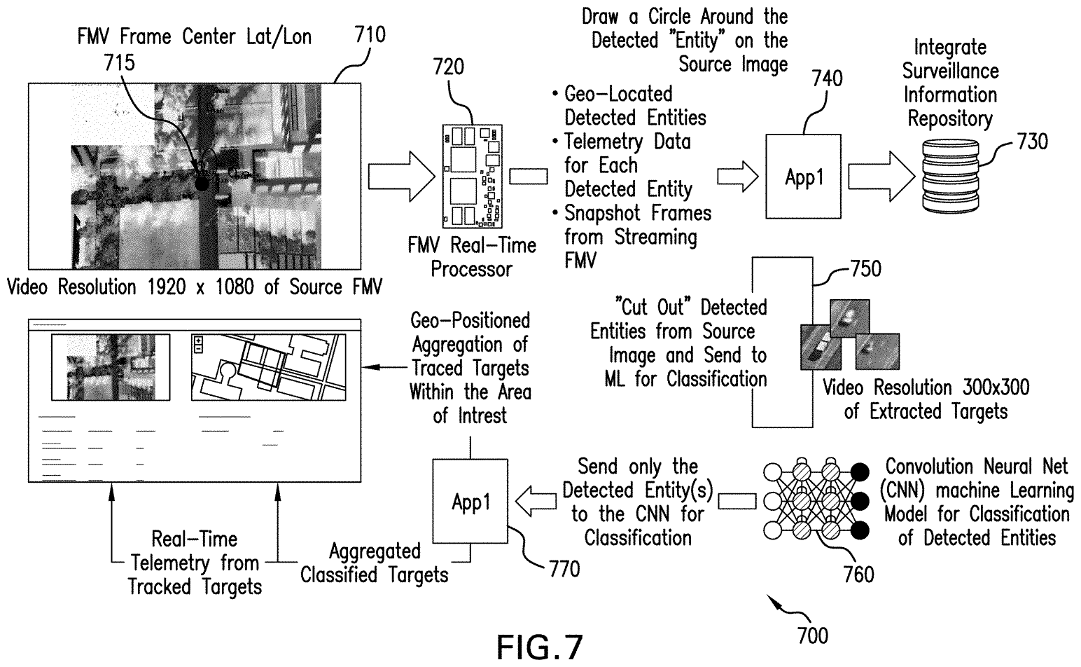

FIG. 7 is a flow diagram showing an exemplary tagging, tracking and locating (TTL) processing flow 700, in accordance with the invention. As shown in FIG. 7, box 710 shows a video signal taken by a video camera. Each frame in the video signal contains a center point 715 called a “Frame Center”, which is denoted by a particular longitude (lon) and latitude (lat). This video signal is sent to a processor, as shown by 720 which may be similar to the processor 110, shown in FIG. 1. Processor 720 geo-locates detected EOTs detected in the video signal in response to user input or commands to monitor particular events of areas, or autonomously such as in response to detection of unusual movements or communications/chatter and sources thereof, unexpected large gatherings and/or particular regions or areas of high risk or potential conflict, provides telemetry data for each EOT, and provides snapshot frames from the streaming video signal (which in some embodiments is FMV). All this information is sent to a translator as shown in 740 (e.g., translator 120 in FIGS. 6 and 1) which identifies detected EOTs on the source image and analyzes only the detected EOTs while not doing any further analysis on the other portions of the image. In other words, the translator “cuts out” the detected EOT from the source image. “Cut out” EOTs are saved in an integrate surveillance information repository as shown in 730, and also transmitted to a machine learning algorithm for classification as shown in 750, such as based on at least one of type, volume, risk level and other predetermined criteria. For example, type may include people walking, skating, bicycling, and/or driving; volume may indicate the number of pedestrians, skaters, bicyclists, and/or drivers performing such activities; and a risk level which may be based on a predetermined scale, such as from 0 to 10 for low to high risk based on geographical location of the EOT and regional news events related to that particular location. In one embodiment, machine learning algorithm 132 of FIG. 1 could serve as the machine learning (ML) shown by reference numeral 750 in FIG. 7. One potential machine learning system is the Convolution Neural Net (CNN) 760. Again, only the detected EOTs are sent to the CNN for classification.

Processing a detected EOT by the CNN 760 is more efficient because there is no loss of spatial resolution of the detected EOTs. No loss occurs because the detected EOTs themselves will be analyzed at full resolution and integrated with source metadata contained in the Surveillance Information Repository 730. With the detected EOTs being analyzed, there is no need to store full-size FMV frames. By extracting and analyzing identified EOTs, far fewer images need to be classified.

After being classified by the CNN 760, the detected EOTs are transmitted to the translator 770 which may be similar to the translator 120 shown in FIGS. 1 and 6. Here the translator 770 aggregates classified EOTs, provides real-time telemetry from tracked targets (EOTs) and predicts potential future locations of the EOT by preforming geo-positioned aggregation of the traced targets within the AOI.

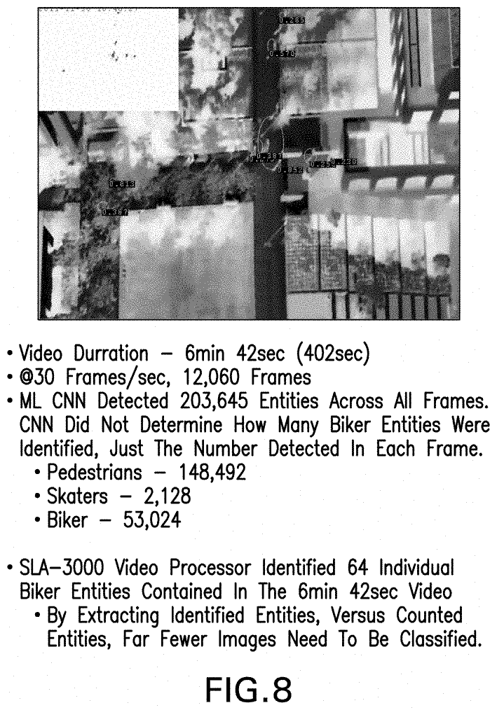

FIG. 8 provides an exemplary FMV video signal. In FIG. 8, the duration of the video signal is 6 minutes and 42 seconds, which is 402 seconds. A standard video format provides 30 frames a second, thus the amount of frames in this example is 12,060 frames. A machine learning algorithm reviewing the incoming video signal found 203,645 entities over all 12,060 frames. According to the machine learning algorithm's classification of the entities in the FMV, the algorithm identified 148,492 pedestrians, 2,128 skaters and 53,024 bikers. By extracting identified entities, versus counted entities, far fewer images need to be classified. For example, if the EOT are bicyclist, then by extracting the identified bicyclist instead of all the identified entities, far fewer images need to be classified, as images without bicyclist are disregarded

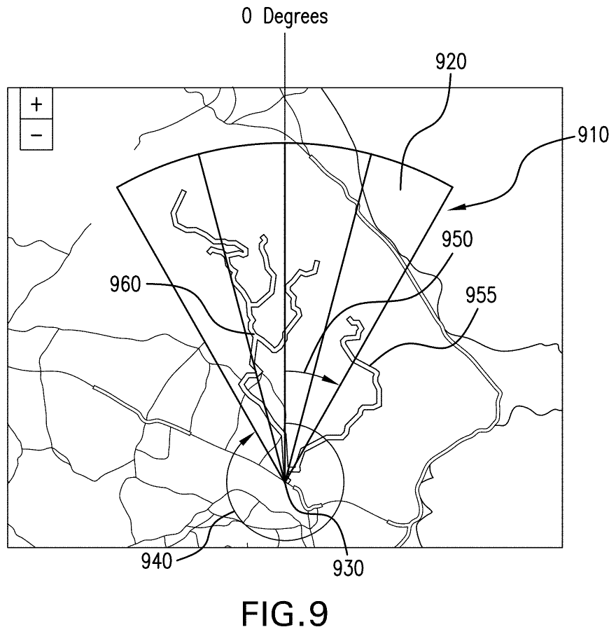

An exemplary application using target path prediction algorithm for use with the invention is shown in FIGS. 9-11, where the AOI is a portion or sector of a map, and the EOT includes roads within the sector. The exemplary target path prediction algorithm provides an exemplary method for predicting a predicative path of the EOT using the system 100, where the AOI includes all possible road traversals during a period of time given a starting point in the AOI, where the roads are the EOTs to be determined.

FIGS. 9-11 describe the exemplary target path predication algorithm using SAP HANA™, however, other database management systems may be used as known by those skilled in the art. A processor is configured to determine the target path prediction algorithm of FIGS. 9-11 as follows:
1. Determine the possible roads or EOTs within in the directed search area or AOI 910. This involves building a polygon in the shape of pizza slices 920 given the start point 930, minimum azimuth, and maximum azimuth of the search area. Azimuths are calculated clockwise from true north. FIG. 9 depicts a search area 910 with starting point 930 being 48.7934; 40.1045 (longitude (lon) and latitude (lat)), minimum azimuth 940 being 330 degrees, and maximum azimuth 950 being 30 degrees.
2. Based upon this search area 910, all roads 955 that intersect with it are placed into a temporary work graph from a predetermined ROADWAYS table or database that contains a geo-spatial representation of all roadways that have been loaded into the system. Alternatively or in addition, the roads may be determined by the processor 110 via image analysis of images obtained by the aerostat 184. The roads 955 are represented as graph edges and the intersections are represented as graph vertices. Also, a road thinning capability is provided based on the value of a STRICT flag that is either 0 or 1 for each ROADWAY. If the roadways are very dense in an area, it is recommended that only major roadways have the STRICT flag set to 1 and are thus displayed, while minor or all other roadways have the STRICT flag set to 0 and are thus disregarded, not displayed, and not considered for traversal. The traversal process accepts as input a STRICT parameter that is used in conjunction with the ROADWAYS.STRICT column value to determine which roadways are considered for traversal. This helps improve performance in areas of high road density. The road thinning capability is incorporated into the logic to increase processing speed, because it has been observed that when there are a large number of edges in the graph then the algorithm processing is much slower. Further, the road thinning capability prevents the display of excessive road which unnecessarily clutter the display with minor undesirable roads. The STRICT parameter value of 0 or 1 may be input by a user via a user interface. Alternatively or in addition, the STRICT parameter may be changed from 0 to 1 in response to the number of roads (to be analyzed and/or displayed) exceeding a predetermined (default) threshold, which may be changed by the user as desired.
3. Next, the shortest off-road path from the starting point 930 to the nearest road in the search area is determined. The intersection point of the nearest road is the starting point 960 for all road traversals that follow. Note that the shortest off-road path determination takes into account obstacles such as waterways and traverses around them.

There are several system configuration parameters that affect off-road processing and are in place to keep acceptable performance. The following parameters are stored in the “HAE_CONFIG”.“HAE.CONF::HAE_CONF” table:
(a) max_offroad_intersects_to_traverse—This configuration parameter limits the number of off-road paths that are considered for traversal processing.
(b) max_offroad_distance_to_traverse_k—This configuration parameter limits the distance that will be traversed off-road.

These configuration parameters improve performance by reducing the number of off-road calculations that are performed.
4. Given the road intersection starting point 960, all possible paths are calculated from the intersection starting point 960 based upon the maximum possible on-road distance that can be travelled in the hours specified by the user of the system.

For example: If the specified travel hours=6, off-road speed=7 kmh, and on-road speed 20 kmh. If it was 7 kilometers from the starting point 930 to the nearest road 950, then off-road travel time took 1 hour, leaving 5 hours of possible on-road travel time. Therefore a maximum of 100 km can be travelled in the remaining 5 hours (5*20 kmh).

This generation of all possible paths takes advantage of the ‘shortest-path to all’ graph algorithm that is built into HANA™. This calculation is very fast compared to conventional methods of traversing the data without a built in graph engine.
5. To improve visualization, the result road network is thinned. This is done by breaking the search area into sub-slices and only including the longest path within the sub-slice in the results. The DENSITY_DEGREES parameter input to the road network calculation procedure determines the amount of thinning that occurs. Note that testing has shown that the performance difference between lower and higher DENSITY_DEGREES is minor. If the DENSITY_DEGREES is not specified, it is defaulted to 3 which is the case for the roads 955 shown in FIG. 9. A DENSITY_DEGREES value of 1 will result in the most paths in the ROAD_NETWORK.

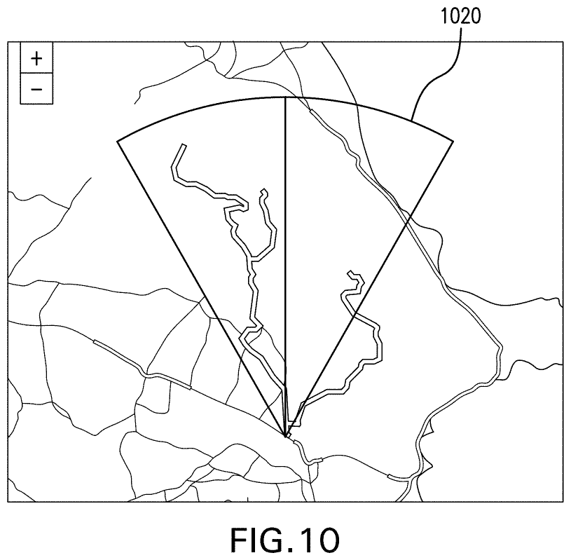

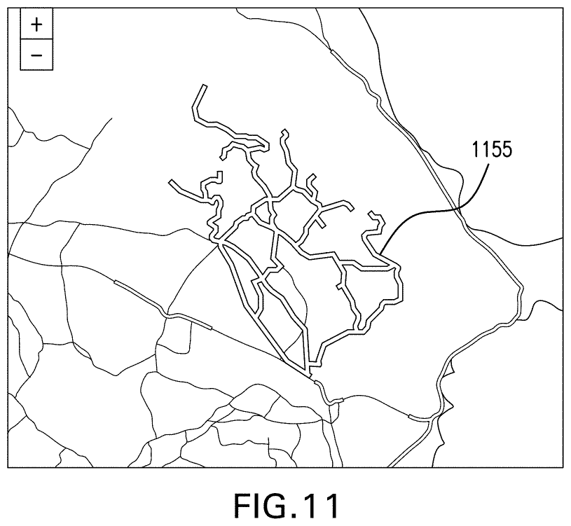

For example: If the directed search area includes 60 degrees and the DENSITY_DEGREES=15, as in FIG. 9, then the search area is divided into 4 sub-slices 920 and only includes the longest path or road 955 within each sub-slice 920. FIG. 10 shows the same degrees search area or EOT 910 of FIG. 9 except that the DENSITY_DEGREES=30 (instead of 15), and thus the search area is divided into 2 sub-slices 1020 (instead of the 4 sub-slices 920 of FIG. 9) FIG. 11 shows that same search area or EOT 910 of FIG. 9 except that the sub-slice boundaries are not shown and the DENSITY_DEGREES value is 1 thus resulting in the most paths or roads 1155 in the ROAD_NETWORK shown in FIG. 11.

Thus, in one embodiment, a system is provided for determining roads traversable during a predetermined travel time in a geographic sector, comprising a memory including computer instructions and a processor, such as the memory 130 and the processor 110 shown in FIG. 1. The processor 110 is coupled to the memory 130 and, in response to executing the computer instructions, is configured to: receive data including all the roads 955 in the geographic sector starting from a starting point 930; divide the geographic sector into slices 920 in response to a value of a density parameter; cause display on a monitor or display 150 (FIG. 1) a longest road in each slice 920 of the slices; determine a road intersection point 960 of a first or starting road starting from the starting point 930 with a nearest intersecting road intersecting with the starting road; and use the road intersection point 960 as a starting point for determining all possible roads 955 for traversals from the road intersection point 960 based on the predetermined travel time and speed of travel over the roads in each slice 920. Accordingly, data is analyzed successively or recursively based on previously determined data. For example, a next or future data or road analysis (such as to determine all possible road traversals from the road intersection point 960) is based on the determined road intersection point 960, which was in turn determined from previous data or road analysis (i.e., determined based on initial or previous starting point 930) roads. Thus, future data analysis (e.g., intersection point 960) is determined based on initial or previous data analysis (e.g., based on the initial or previous starting point 930). The data analyzed by the processor 110 (to determine all the roads traversable during a predetermined travel time in a geographic sector) may be provided to the processor 110 from a predetermined database, and/or determined by the processor 110 based on image analysis of an image(s) of the geographic sector.

The processor of the invention is operable for providing control signals and/or performing operations in response to input signals from the UI as well as in response to other devices of the system, including executing instructions or modules stored in the memory, such as modules that include computer instructions for implanting the various processes and methods described herein. The processor may include one or more a microprocessor, an application-specific or general-use integrated circuit(s), a logic device, for example. Further, the processor may be a dedicated processor for performing all the steps of the invention or may be a general-purpose processor where only one or several functions operate for performing in accordance with the present system. The processor may operate utilizing a program portion, multiple program segments, or may be a hardware device utilizing a dedicated or multi-purpose integrated circuit.

The modules, computer programs, instructions and/or program portions contained in the memory may configure the processor to implement the methods, operations, acts, and functions disclosed herein. The processor so configured becomes a special purpose machine or processor particularly suited for performing the methods, operations, acts, and functions. The memory functions may be distributed, for example, between systems, clients and/or servers, or local, and the processor, where additional processors may be provided, which may also be distributed or may be singular. The memory functionalities may be implemented as electrical, magnetic or optical memory, or any combination of these or other types of storage devices. Moreover, the term “memory” should be construed broadly enough to encompass any information able to be read from or written to an address in an addressable space accessible by the processor. With this definition, information accessible through a network is still within the memory, for instance, because the processor may retrieve the information from the network for operation in accordance with the invention.

It will be appreciated by persons having ordinary skill in the art that many variations, additions, modifications, and other applications may be made to what has been particularly shown and described herein by way of embodiments, without departing from the spirit or scope of the invention. Therefore it is intended that the scope of the invention, as defined by the claims below, includes all foreseeable variations, additions, modifications or applications.

Finally, the above-discussion is intended to be merely illustrative of the present system and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the invention as set forth in the claims that follow. Accordingly, the specification and drawings are to be regarded in an illustrative manner and are not intended to limit the scope of the appended claims.

What is claimed is:

1. A system for identifying and determining predictions of an entity of interest (EOT), comprising:
a processor configured to receive a video signal of an area of interest (AOI);
a memory storing a machine learning algorithm for use in identifying the EOT in the AOI and storing a database for use in classifying the EOT and determining predictions associated with the EOT, the memory being operatively coupled to the processor;
a display operatively coupled to the processor;
a user interface operatively coupled to the processor and configured to receive a user input; and
a translator operatively coupled to the processor and configured to cause the processor to operationally communicate with the machine learning algorithm,
wherein the processor is configured to:
identify video data from each video frame associated with the video signal,
store the video data in the database as stored video data,
receive a current video signal of the AOI and identify current video data from each video frame associated with the current video signal,
identify the EOT from the stored video data and the current video data using the machine learning algorithm, and store the EOT in the database,
correlate the stored video data with the current video data to update the stored video data and generate correlated video data,
cause the database to store the correlated video data with its associated EOT, and
identify trends in the correlated video data, thereby determining predictions associated with the EOT, and
wherein the display is configured to display at least a portion of the database.

2. The system of claim 1, wherein the user interface is configured to request a user input to manipulate a source of the video data in response to the predictions determined by the processor based on the correlated video data.

3. The system of claim 2, wherein the source of the video data is an aerostat operationally coupled to the processor.

4. The system of claim 1, wherein the processor is configured to provide a manipulation to manipulate a source of the video data based on the predications determined by the processor.

5. The system of claim 4, wherein the processor is configured to display the manipulation on the display.

6. The system of claim 5, wherein the user interface is configured to receive a user input to change the manipulation.

7. The system of claim 1, wherein the video data and the current video data each comprise telemetry data, metadata of the video frame and image data associated with the video frame.

8. The system of claim 1, wherein the processor is configured to display on the display at least one of the trends identified and the predictions associated with the EOT.

9. The system of claim 8, wherein the predictions determined by the processor comprise predictions associated with at least one of a predictive path of the EOT, a predictive identity of the EOT, a predictive location of the EOT, a predictive action of the EOT, a predictive movement of the EOT, a predictive type of the EOT, a predictive classification of the EOT, and a predictive trend of the EOT.

10. The system of claim 1, wherein the AOI is a sector of a map, and the EOT includes roads within the sector.

11. A system for determining roads traversable during a predetermined travel time in a geographic sector, comprising:
a memory including computer instructions; and
a processor coupled to the memory and, in response to executing the computer instructions, is configured to:
receive data including all the roads in the geographic sector starting from a starting point,
divide the geographic sector into slices in response to a value of a density parameter,
cause display on a monitor a longest road in each slice of the slices,
determine a road intersection point of a first road starting from the starting point with a nearest road,
use the road intersection point as a starting point for determining all possible roads for traversals from the road intersection point based the predetermined travel time and speed of travel over the roads in the each slice.

12. The system of claim 11, wherein the data is obtained from a map stored in a database.

13. The system of claim 11, wherein the data is obtained from image analysis of an image of the geographic sector.
